(19) United States
(12) Patent Application Publication
(10) Pub. No.: US 2025/0146357 A1
(43) Pub. Date: May 8, 2025

(54) MOTORISED ROLLER BLIND AND WAND ASSEMBLY

(71) Applicant: ROLLEASE ACMEDA, INC., Stamford, CT (US)

(72) Inventor: Jonny Emilio Matuichuk, Stamford, CT (US)

(21) Appl. No.: 18/934,408

(22) Filed: Nov. 1, 2024

(30) Foreign Application Priority Data
Nov. 8, 2023 (AU) 2023903582

(51) Int. Cl. E06B 9/44; E06B 9/68; E06B 9/72

(52) U.S. Cl. CPC E06B 9/44; E06B 9/72; E06B 2009/6809

(57) ABSTRACT

A wand assembly for controlling operation of a motorised cover such as a roller blind. The motorised cover includes a motor configured to selectively adjust the position of the blind relative to an architectural opening. The wand assembly includes an operating stork having a control panel at one end for controlling operation of the motor and an adaptor configured to operatively connect the operating stork to the motor and enable the operating stork to hang therefrom. The operating stork includes an interface at one end that releasably attaches the operating stork to a complementary interface of the adaptor, which operably connects the control panel of the operating stork to the motor via the adaptor. The adaptor is configured to remain connected to the motor when the operating stork is disconnected. The operating stork is selectively connected to the adaptor when needed for controlling of the blind.

### CROSS-REFERENCE TO RELATED APPLICATION

This application claims priority to and the benefit of the filing date of Australian Provisional Patent Application No. 2023903582, filed Nov. 8, 2023, the entire disclosure of which is hereby incorporated herein by reference.

### TECHNICAL FIELD

The present disclosure relates to a wand assembly for controlling a motorised cover over an architectural opening. More specifically, the present disclosure relates to a motorised roller blind and wand assembly for controlling operation of the roller blind.

### BACKGROUND ART

Motorised window coverings typically include a component that is rotatable to extend and retract the covering, for example a curtain, blind or the like. Such assemblies typically have a battery powered motor to drive a mechanism that is rotatable. The motor is controlled by a remote control unit and the battery to drive the motor is recharged via a mains power cable which plugs into a port associated with the motor. As motorised window coverings are installed high up (e.g. above a window) and are not always easy to access, the port may not always be easily accessed from floor level. Accordingly, it can be difficult to plug the power cable into the port without standing on a chair or ladder.

It would be desirable to provide a wand assembly for controlling a motorised cover which has one or more improved features.

In this specification, unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### SUMMARY

In accordance with a first aspect of the present disclosure, there is provided a wand assembly for controlling operation of a motorised cover assembly, the motorised cover assembly having a motor assembly configured to selectively adjust the position of a cover relative to an architectural opening, the wand assembly comprising an operating stork having a control panel for controlling operation of the motor assembly, and an adaptor configured to operatively connect the stork to the motor assembly, the adaptor comprising an electrical connector for coupling with
a complementary electrical connector of the motor assembly, the stork comprising an interface for releasably attaching the stork with a complementary interface of the adaptor, the stork interface comprising a plurality of electrical contacts configured to form an electrical connection with a corresponding plurality of electrical contacts of the adaptor interface to operably connect the control panel of the stork to the motor assembly via the adaptor.

The releasable attachment of the stork interface with the adapter interface may be provided by a coupling member of the stork interface engaging with a complementary coupling part of the adaptor. In at least one embodiment, the releasable attachment is provided by magnetic attraction between the coupling member of the stork interface and the coupling part of the adaptor, the magnetic attraction preferably providing a force sufficient for the stork to hang under its own weight from the adaptor and maintain the electrical connection. The coupling member and coupling part may both comprise at least one magnetic element to provide the magnetic attraction.

In one embodiment, the interface of the stork may be formed in a head section provided at a distal end of the stork. The head section may comprise an upstanding peripheral sidewall providing a recess into which the interface of the adaptor is configured to seat when forming the electrical connection between the stork and adaptor. The plurality of electrical contacts of the stork interface may project from a bottom surface of the recess and the at least one magnetic element of the coupling member may be provided in the recess and at least in-part surrounds the electrical contacts of the stork interface.

In another embodiment, the interface of the stork is formed in a head section provided at a distal end of the stork, and the adaptor may comprise an upstanding peripheral sidewall providing a recess into which the interface of the stork is configured to seat when forming the electrical connection between the stork and adaptor. The plurality of electrical contacts of the adaptor interface may project from a bottom surface of the recess and the at least one magnetic element of the coupling part may be provided in the recess and at least in-part surrounds the electrical contacts of the adaptor interface.

The head section of the stork may be pivotable and the control panel can be provided at an opposite proximal end of the stork. The stork may further include an elongate main body having a first end and a second end and an internal passageway configured for passage of electrical cabling from the interface of the stork to the control panel, the pivotal head section being positioned at the first end of the main body and the control panel being positioned at the second end of the main body.

The control panel may include a plurality of buttons configured to operate the motor assembly. Further, the control panel may include a charging/programming port via which a rechargeable battery, housed within the motor assembly, may be recharged.

In some forms, the electrical connector of the adaptor is a micro-USB plug and the complementary electrical connector of the motorised cover assembly is a micro-USB port.

In at least one embodiment, the motorised cover assembly is a motorised roller blind assembly having an elongate tube for supporting a retractable screen, a motor assembly of the roller blind assembly being configured to rotate the tube to selectively adjust the screen in response to control inputs from the control panel.

In accordance with another aspect of the present disclosure, there is provided a motorised roller blind assembly in combination with a wand assembly, the wand assembly being configured to control operation of the motorised roller blind assembly, the motorised roller blind assembly having a motor assembly configured to selectively adjust the position of a retractable screen relative to an architectural opening, the wand assembly comprising: an operating stork having a control panel for controlling operation of the motor assembly, and an adaptor configured to operatively connect the stork to the motor assembly, the adaptor comprising an electrical connector for coupling with a complementary electrical connector of the motor assembly, the stork comprising an interface for releasably attaching the stork with a complementary interface of the adaptor, the stork interface comprising a plurality of electrical contacts configured to form an electrical connection with a corresponding plurality of electrical contacts of the adaptor interface to operably connect the control panel of the stork to the motor assembly via the adaptor. The adapter may be fixed to the motor assembly and remain in place when the stork is manipulated to separate the stork from the adapter.

In accordance with another aspect of the present disclosure, there is provided an operating stork for controlling operation of a motorised cover assembly, the motorised cover assembly comprising a motor assembly configured to selectively adjust the position of a cover relative to an architectural opening, the motor assembly having an adaptor configured to operatively connect with the stork, the operating stork comprising:
a control panel for controlling operation of the motor assembly, and
an interface for releasably attaching the stork with a complementary interface of the adaptor,
wherein the stork interface comprises a plurality of electrical contacts configured to form an electrical connection with a corresponding plurality of electrical contacts of the adaptor interface to operably connect the control panel of the stork to the motor assembly.

In accordance with another aspect of the present disclosure, there is provided an adaptor for operatively connecting an operating stork to a motor assembly of a motorised cover assembly, the motor assembly being configured to selectively adjust the position of a cover relative to an architectural opening, the adaptor comprising:
an electrical connector for coupling with a complementary electrical connector of the motor assembly,
an interface for releasably attaching the adaptor with a complementary interface of the stork, and
a control panel for controlling operation of the motor assembly,
wherein the adaptor interface comprises a plurality of electrical contacts configured to form an electrical connection with a corresponding plurality of electrical contacts of the stork interface to operably connect the control panel of the stork to the motor assembly via the adaptor.

### BRIEF DESCRIPTION OF DRAWINGS

Various embodiments/aspects of the disclosure will now be described with reference to the following figures

FIG. 1A is a perspective view of the wand assembly, in accordance with an embodiment of the invention attached to a roller blind;

FIG. 1B is a perspective view of the motor assembly connected to the adaptor with the stork of the wand assembly separate from the adaptor;

FIG. 2 is a perspective view of the wand assembly shown in FIG. 1B attached to the motor assembly;

FIG. 3 is an exploded view of the components of the wand assembly and motor assembly illustrated in FIG. 2;

FIG. 4 is a detailed perspective view of the head section of the operating stork of the wand assembly shown in FIG. 3;

FIG. 5 is a detailed perspective view of the connection of the wand assembly to the motor assembly;

FIG. 6 is a block diagram of the electrical interconnection of the printed circuit board of the motor assembly and the printed circuit board of the stork's control panel via the micro-USB plug of the motor assembly and adaptor of the wand assembly, in accordance with an embodiment;

FIG. 7 is a perspective view of the control panel at the bottom end of the stork;

FIG. 8 is a perspective view of the head portion of the motor assembly showing the micro-USB receptacle of the head portion without the adaptor of the wand assembly;

FIG. 9A is a perspective view of the adaptor component of the wand assembly in accordance with one embodiment;

FIG. 9B is a perspective view of the underside of the adaptor component illustrated in FIG. 9A, and

FIG. 9C is a close-up detailed perspective view of the head section of the operating stork illustrated in FIG. 4.

### DETAILED DESCRIPTION

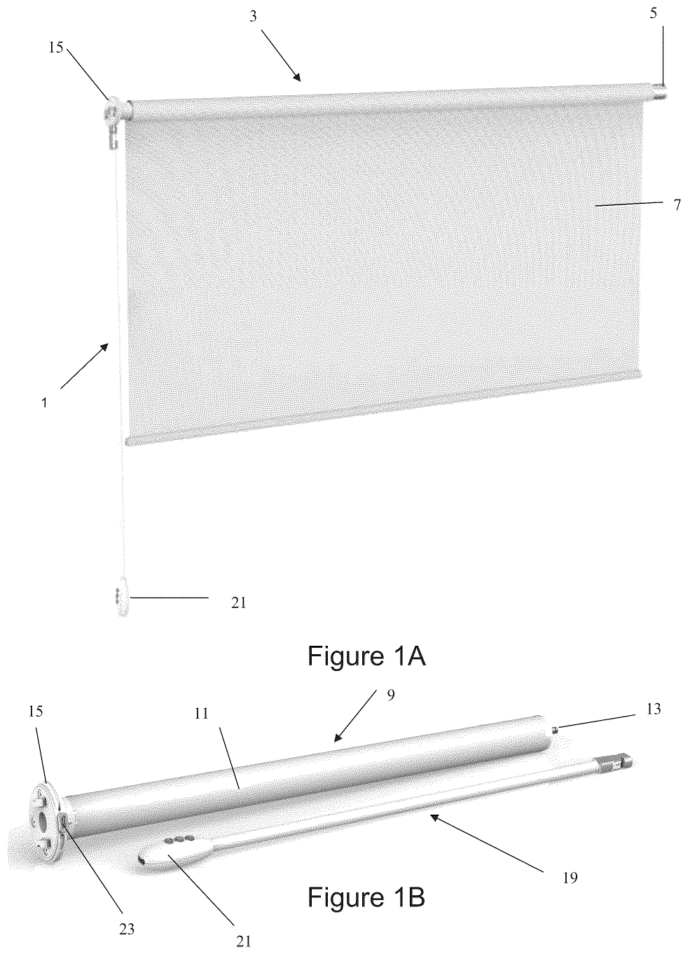

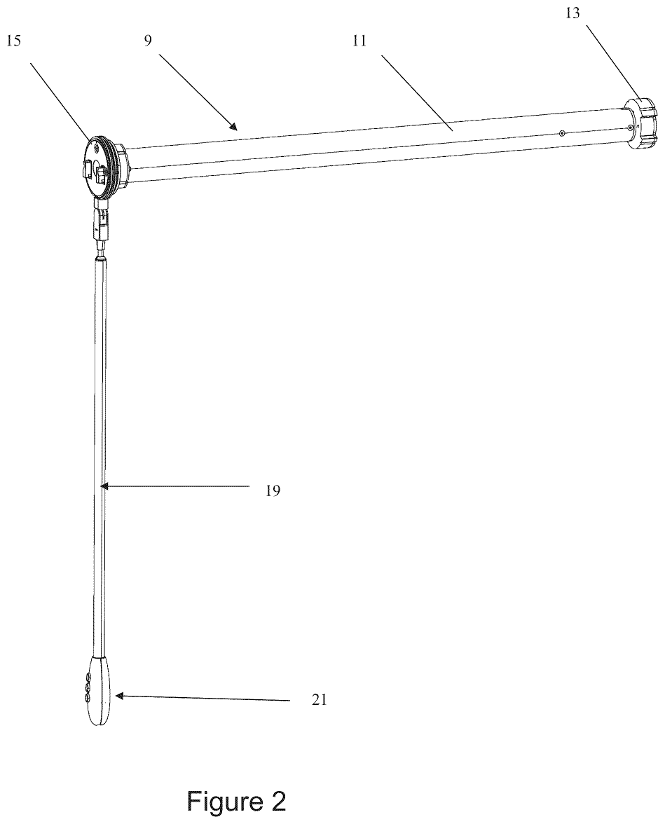

Disclosed herein is a wand assembly 1 for controlling operation of a motorised cover assembly having a motor configured to selectively adjust the position of a cover relative to an architectural opening, for example a curtain or retractable screen relative to a window, door or any other similar opening of a building structure. FIGS. 1A and 1B show the wand assembly 1 for controlling operation of a motorised cover assembly. In the detailed form, the motorised cover assembly is a motorised roller blind assembly 3. As shown in FIGS. 1A and 1B, the roller blind assembly 3 includes an elongate tube 5 for supporting a retractable screen (e.g. a length of fabric) 7. A motor assembly 9 of the roller blind assembly 3 is typically housed within the tube 5 and includes a motor 11 and associated drive member 13 which is configured to rotate the tube 5 about a longitudinal axis of the tube 5 to extend and retract the screen 7 in use.

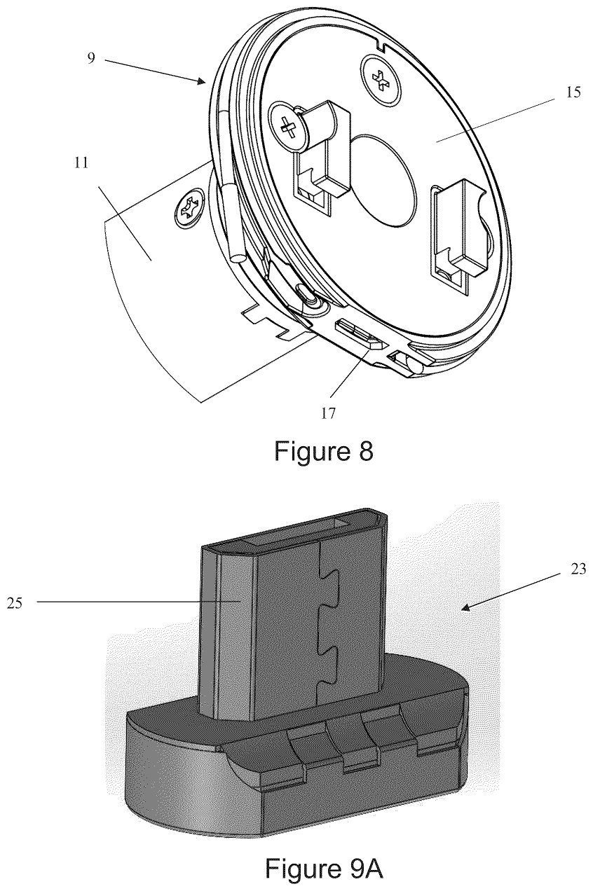

The motor assembly 9 also includes a head portion 15 at one end which is operatively connected to the motor 11 and drive member 13. The head portion 15 is disposed within and protrudes from an end of the elongate tube 5 about which the retractable screen 7 is wound. As best illustrated in FIG. 8, the head portion 15 includes an electrical connector which is preferably in the form of a micro-USB port or receptacle 17. The USB port 17 provides the means by which a rechargeable battery, housed within the assembly to provide power to the motor, may be recharged. In addition the USB port 17 provides the means by which the wand assembly 1 may communicate and power the motor assembly 9 to operate the retractable screen 7, and provide functions such as setting limits, checking the battery level, changing motor speed and setting a favourite position for the screen 7. In this respect, the USB port 17 is provided on a printed circuit board (PCB) 18, associated with the motor 11 and rechargeable battery, which is positioned in the head portion 15 of the motor assembly 9. The motor assembly 9 includes embedded firmware logic that facilitates rotational movement of the elongate tube 5 via the drive member 13 to extend/retract the screen 7 depending upon the direction of rotation.

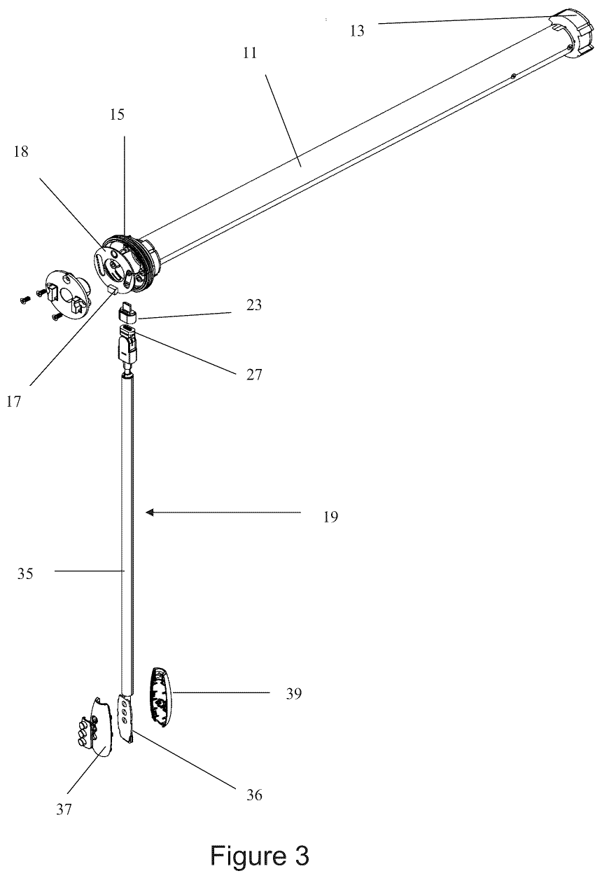

The wand assembly 1 in accordance with a preferred embodiment of the disclosure includes an operating stork 19 having a user interface in the form of control panel 21 at a proximal end of the stork 19 for controlling operation of the motor assembly 9, for example to selectively extend and retract the retractable screen 7. As best illustrated in FIGS. 1B, 3, 9A and 9B, the wand assembly 1 further includes an adapter 23 configured to operatively connect the stork 19 to the motor assembly 9 and enable the stork 19 to hang. In this regard, the adaptor 23 comprises an electrical connector which is preferably in the form of a micro-USB plug 25 which can plug into the complementary electrical connector of the motor assembly 9, for example the micro-USB port 17. The adaptor 23 is intended to remain in the USB port 17 when not in use and the stork 19 disconnected. The stork 19 can be readily connected to the adaptor 23 when needed for controlling of the roller blind. In order to prevent/minimise the likelihood of the USB plug 25 of the adaptor 23 inadvertently being separated from the USB port 17, for example when the stork 19 is hanging for the adaptor 23 and being operated by a user, an adhesive may be applied to secure the USB plug 25 in the USB port 17. In another embodiment not illustrated, the adaptor 23 may be integrally formed with the motor assembly 9, for example the PCB, thereby avoiding the need for the USB connection between the adaptor 23 and the motor assembly 9. The adaptor 23 is thereby intended to be a non-removeable/fixed component of the motor assembly 9 in this embodiment, which means for example, that the adaptor 23 cannot be removed from the motor assembly 9 without substantial force being applied.

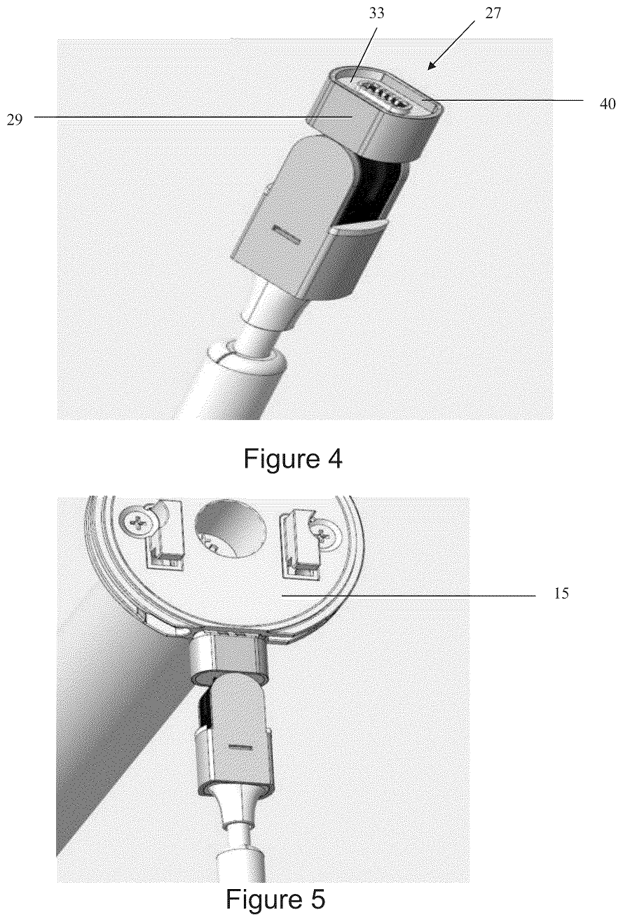

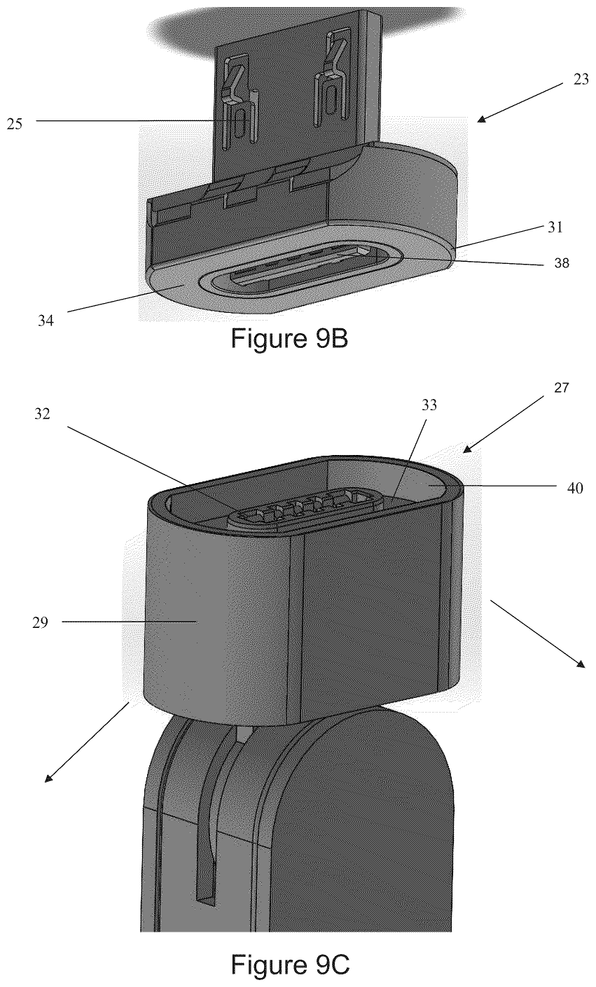

The stork 19 further includes an interface 27 which is preferably formed in a head component 29 provided at a distal end of the stork 19, as illustrated in FIGS. 4 and 9C. The head component 29 may be fixed or pivotable to allow for operational back and forth movement of the stork 19 of up to about 90° from a substantially upright position perpendicular to a longitudinal axis of the elongate tube 5. The stork interface 27 is configured to releasably attach the distal end of the stork 19 to a complementary interface 31 of the adaptor 23 to preferably provide a releasable electrical connection between the stork 19 and adaptor 23 and a separate releasable structural connection between the stork 19 and adaptor 23 which is sufficient to support the weight of the stork 19. In this regard, as shown in FIG. 9C, the stork interface 27 includes a plurality of electrical contacts 32 which form an electrical connection with a corresponding plurality of electrical contacts 38 of the adaptor interface 31 when the stork 19 is attached to adaptor 23. The electrical connection formed results in the control panel 21 being operably connected to the motor assembly 3 to facilitate the desired communications and control of the motor assembly 3 via the intermediate adaptor 23.

To facilitate the releasable structural connection between the stork 19 and adaptor 23, the stork interface 27 may further include a quick-connect coupling member which engages with a complementary quick-connect coupling member of the adaptor 23 in order to releasably maintain the electrical connection. In this respect, the stork 19 typically hangs from the adaptor 23 in use so the coupling between the stork 19 and adaptor 23 ideally needs to be at least sufficient to support the weight of the stork 19. Preferably, the coupling between the stork 19 and adaptor 23 does not require a user to reach or physically touch the coupling to attach and remove the stork 19. Instead, the stork 19 can preferably be connected and released from the adaptor 23 by the user holding the stork 19, for example a lower section of the stork 19 near the control panel 21. Preferably, the electrical connection is provided simultaneously with the coupling of the stork 19 to the adaptor 23. Likewise, the release of the electrical connection preferably occurs simultaneously with the release of the coupling. The coupling may be in the form of a bayonet mount, a tapered interference fit, a threaded connection, a ball bearing detent, cam lock or other fastening means. In a preferred embodiment, the interface coupling between the stork 19 and the adaptor 23 is provided by magnetic attraction. In this respect, the coupling members may be in the form of one or more magnetic elements provided on both interfaces 27, 31. For example, the stork interface 27 may include one or more magnetic elements 33, for example one or more magnets, with the adaptor interface 31 including one or more elements, for example one or more magnets 34 of opposite polarity to that of the polarity of the stork interface magnets 33. Accordingly, the magnetic field generated attracts the stork interface 27 to the adaptor interface 31. The magnets may be permanent magnets and either the stork interface magnet 33 or adaptor interface magnet 34 may be substituted with a ferromagnetic material. With reference to FIGS. 4 and 9C, the magnetic element 33 of the stork interface 27 may be provided around the centrally located electrical contacts 32. A similar configuration is provided on the adaptor interface 31 for the electrical contacts 38 and one or more magnetic elements 34. The electrical contacts 32 of the stork interface 27 and corresponding electrical contacts 38 of the adaptor interface 31 may also both be aligned in a row. The head component 29 within which the stork interface 27 is formed may include an upstanding peripheral sidewall 40 which surrounds the stork's one or more interface magnets 33 and electrical contacts 32 to provide a recess into which the adaptor interface 31 can be seated when forming the electrical connection between the stork 19 and the adaptor 23. Further, the electrical contacts 32 may protrude upwardly from a bottom surface of the recess with the one or more interface magnets 33 being located at the bottom of the recess and surrounding the electrical contacts 32. The one or more magnetic elements 34 of the adaptor interface 31 are preferably configured to abut with the magnetic elements 33 of the stork interface 27 when the adaptor 23 is seated within the recess. The electrical contacts 38 of the adaptor 23 may also be recessed within a centrally located cavity which is of complementary shape to that of the protruding electrical contacts 32 in the stork interface 19. In an alternative arrangement, the adaptor 23 may include the upstanding peripheral sidewall rather than the head component 29 of the stork 19. In this respect the upstanding peripheral sidewall may surround the adaptor's one or more interface magnets 34 and electrical contacts 38 to provide a recess into which the stork interface 27 can be seated when forming the electrical connection between the stork 19 and the adaptor 23.

The stork 19 includes an elongate main body 35 which is preferably tubular and has an internal passage extending therethrough for passage of electrical cabling from the electrical contacts 32 of the stork interface 27 to a PCB 36 of the control panel 21 at the proximal end of the operating stork 19. The elongate main body 35 and control panel 21 may be able to axially pivot about a longitudinal axis of the main body 35 relative to the distal end of the stork 19. This enables the control panel 21 to be turned to a position best suited for access by a user. The control panel 21 includes front and back housing members 37, 39 which join together and house within the PCB 36 of the control panel 21. The control panel 21 further includes one or more control buttons connected to the PCB 36. The control buttons may protrude from the front housing member 37 and are configured to be pressed by a user to provide input commands, for example for the control of the motor assembly 9. With reference to the FIG. 7, the control buttons include a first (up) button 41 which when pressed commands the motor assembly 9 to raise the screen 7, a second (stop) button 43 which when pressed commands that motor assembly 9 to stop the screen 7, and a third (down) button 45 which when pressed commands the motor assembly 9 to lower the screen 7. A favourite position for the screen 7 can also be set by pressing either the first or third button 41, 45 simultaneously with the second button 43.

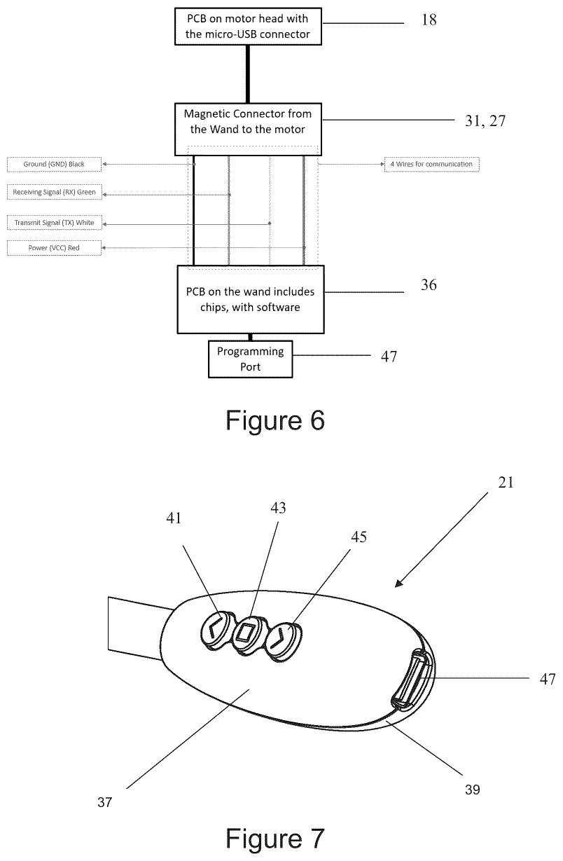

With reference to FIG. 6, a block diagram is provided of the electrical interconnection of the PCB 18 of the motor assembly 9 to the PCB 36 of the stork's control panel 21. In the detailed embodiment, the entire electrical interconnection is concealed with no exposed electrical cabling between the stork 19 and the motor assembly 9. Serial communication data may be transmitted via a 5^{th} wire of the micro-USB cable.

As illustrated in FIG. 7, the control panel 21 may also include a charging/programming port 47 at the bottom of the control housing via which a rechargeable battery, housed within the motor assembly 9, may be recharged. The port 47 may also be utilised to connect to an external power source to enable the operation in the event that the rechargeable battery is flat.

As blinds (and thus the associated motor assembly 9) are installed high up (e.g. above a window) and/or are not always easy to access, the communication port 17 in the head portion 15 of the motor assembly 9 may not always be visible and easily reached. Advantageously, the wand assembly 1 disclosed herein avoids the need for the port 17 of the motor assembly 9 to be reached and manually connected by hand each time control of the motor is required.

The word ‘comprising’ and forms of the word ‘comprising’ as used in this description and in the claims does not limit the invention claimed to exclude any variants or additions.

Modifications and improvements to the invention will be readily apparent to those skilled in the art. Such modifications and improvements are intended to be within the scope of this invention.

What is claimed is:

1. A wand assembly for controlling operation of a motorised cover assembly, the motorised cover assembly comprising a motor assembly configured to selectively adjust the position of a cover relative to an architectural opening, the wand assembly comprising:
an operating stork comprising a control panel for controlling operation of the motor assembly, and
an adaptor configured to operatively connect the stork to the motor assembly, the adaptor comprising an electrical connector for coupling with a complementary electrical connector of the motor assembly,
the stork comprising an interface for releasably attaching the stork with a complementary interface of the adaptor, the stork interface comprising a plurality of electrical contacts configured to form an electrical connection with a corresponding plurality of electrical contacts of the adaptor interface to operably connect the control panel of the stork to the motor assembly via the adaptor.

2. The wand assembly of claim 1, wherein the releasable attachment of the stork interface with the adapter interface is provided by a coupling member of the stork interface engaging with a complementary coupling part of the adaptor.

3. The wand assembly of claim 2, wherein the releasable attachment is provided by magnetic attraction between the coupling member of the stork interface and the coupling part of the adaptor, the magnetic attraction providing a force sufficient for the stork to hang under its own weight from the adaptor and maintain the electrical connection.

4. The wand assembly of claim 3, wherein the coupling member and coupling part both comprise at least one magnetic element to provide the magnetic attraction.

5. The wand assembly of claim 1, wherein the interface of the stork is formed in a head section provided at a distal end of the stork, the head section comprising an upstanding peripheral sidewall providing a recess into which the interface of the adaptor is configured to seat when forming the electrical connection between the stork and adaptor.

6. The wand assembly of claim 5, wherein the plurality of electrical contacts of the stork interface project from a bottom surface of the recess and the at least one magnetic element of the coupling member is provided in the recess and at least in-part surrounds the electrical contacts of the stork interface.

7. The wand assembly of claim 1, wherein the interface of the stork is formed in a head section provided at a distal end of the stork, the adaptor comprising an upstanding peripheral sidewall providing a recess into which the interface of the stork is configured to seat when forming the electrical connection between the stork and adaptor.

8. The wand assembly of claim 7, wherein the plurality of electrical contacts of the adaptor interface project from a bottom surface of the recess and the at least one magnetic element of the coupling part is provided in the recess and at least in-part surrounds the electrical contacts of the adaptor interface.

9. The wand assembly of claim 1, wherein the head section of the stork is pivotable and the control panel is provided at an opposite proximal end of the stork.

10. The wand assembly of claim 6, wherein the stork further includes an elongate main body having a first end and a second end and an internal passageway configured for passage of electrical cabling from the interface of the stork to the control panel, the pivotal head section being positioned at the first end of the main body and the control panel being positioned at the second end of the main body.

11. The wand assembly of claim 1, wherein the control panel includes a plurality of buttons configured to operate the motor assembly.

12. The wand assembly of claim 1, wherein the control panel includes charging/programming port via which a rechargeable battery, housed within the motor assembly, may be recharged.

13. The wand assembly of claim 1, wherein the electrical connector of the adaptor is a micro-USB plug and the complementary electrical connector of the motorised cover assembly is a micro-USB port.

14. The wand assembly of claim 1, wherein the motorised cover assembly is a motorised roller blind assembly having an elongate tube for supporting a retractable screen, a motor assembly of the roller blind assembly being configured to rotate the tube to selectively adjust the screen in response to control inputs from the control panel.

15. A motorised roller blind assembly in combination with a wand assembly, the wand assembly being configured to control operation of the motorised roller blind assembly, the motorised roller blind assembly comprising a motor assembly configured to selectively adjust the position of a retractable screen relative to an architectural opening, the wand assembly comprising:
an operating stork comprising a control panel for controlling operation of the motor assembly, and
an adaptor configured to operatively connect the stork to the motor assembly, the adaptor comprising an electrical connector for coupling with a complementary electrical connector of the motor assembly,
the stork comprising an interface for releasably attaching the stork with a complementary interface of the adaptor, the stork interface comprising a plurality of electrical contacts configured to form an electrical connection with a corresponding plurality of electrical contacts of the adaptor interface to operably connect the control panel of the stork to the motor assembly via the adaptor.

16. The motorised roller blind assembly in combination with the wand assembly of claim 15, wherein the adapter is fixed to the motor assembly and remains in place when the stork is manipulated to separate the stork from the adapter.

17. An operating stork for controlling operation of a motorised cover assembly, the motorised cover assembly comprising a motor assembly configured to selectively adjust the position of a cover relative to an architectural opening, the motor assembly having an adaptor configured to operatively connect with the stork, the operating stork comprising:
a control panel for controlling operation of the motor assembly, and
an interface for releasably attaching the stork with a complementary interface of the adaptor,
wherein the stork interface comprises a plurality of electrical contacts configured to form an electrical connection with a corresponding plurality of electrical contacts of the adaptor interface to operably connect the control panel of the stork to the motor assembly.
